(19) United States
(12) Patent Application Publication
(10) Pub. No.: US 2005/0245659 A1
(43) Pub. Date: Nov. 3, 2005

(54) Thermal interface material and method for manufacturing same

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/991,022

(22) Filed: Nov. 17, 2004

(30) Foreign Application Priority Data
Apr. 29, 2004 (CN) 200410027103.3

(51) Int. Cl. B43K 1/00; B32B 31/00

(52) U.S. Cl. 524/439; 156/62

(57) ABSTRACT

A thermal interface material (10) includes a thermal grease (11) and at least one shape memory alloy (12) dispersed in the thermal grease. The shape memory alloy is preferably a nano-NiTiCu alloy, which enhances thermal contact between an electronic device (30) and a heat sink. The thermal interface material has the Shape Memory Effect, and can have a large surface area for large-sized applications. A method for manufacturing the thermal interface material includes the steps of: (a) providing a thermal grease; (b) dispersing one or more shape memory alloys in the thermal grease at an operating temperature of a heat source; (c) applying the thermal grease between the heat source and a heat dissipating device at the operating temperature of the heat source; and (d) cooling and solidifying the thermal grease to form the thermal interface material.

### BACKGROUND OF THE INVENTION

1. Field of the invention

The invention relates generally to thermal interface materials and manufacturing methods thereof, and more particularly to a kind of thermal interface material which enhances contact between a heat source and a heat dissipating device, and a manufacturing method thereof.

2. Description of Related Art

Electronic components such as semiconductor chips are becoming progressively smaller, and the operating speeds thereof are becoming progressively higher. Correspondingly, the heat dissipation requirements of these components are increasing too. In many contemporary applications, a heat dissipating device is fixed on or near the electronic component to dissipate heat therefrom. Generally, however, there is a clearance between the heat dissipating device and the electronic component. The heat dissipating device does not engage with the electronic component compactly. Therefore, the heat produced in the electronic component cannot be efficiently transmitted to the heat dissipating device for dissipation to the external environment.

In order to enhance the contact between the heat dissipating device and the electronic component, a thermal interface material can be utilized between the electronic component and the heat dissipating device. Commonly, the thermal interface material is thermal grease. The thermal grease is compressible, and has high thermal conductivity. Furthermore, a material having high thermal conductivity can be mixed in with the thermal grease to improve the heat conducting efficiency of the thermal grease. However, when the thermal grease absorbs the heat produced by the electronic component, the temperature thereof rises, and the thermal grease is transformed. This results in incomplete contact between the heat dissipating device and the thermal grease, thus reducing the heat transfer efficiency of the thermal grease.

In order to improve the heat transfer efficiency of thermal interface materials, one approach is to reduce thermal interface resistance. Thermal interface resistance is directly proportional to a size of a thermal interface gap. Typically, there is an interface resistance between the electronic component and the thermal interface material, and an interface resistance between the thermal interface material and the heat dissipating device. One means to reduce an interface resistance is to reduce the thermal interface gap size. U.S. Pat. No. 6,294,408 discloses a method for controlling a thermal interface gap distance. In the method, by applying a force at room temperature, a thermal interface material is compressed to its final thickness, and is disposed between a circuit chip and a substantially flat thermally conductive lid. The thickness is the desired thickness for the thermal gap.

In the above-described method, the thermal interface material is compressed at room temperature. However, when the circuit chip, the thermally conductive lid and the thermal interface material heat up to an operating temperature of the circuit chip, they expand at different rates and change shape differently. Usually, the thermal gap between the thermal interface material and the thermally conductive lid is thereby enlarged. The resistance of the thermal interface material is increased, and the heat transfer efficiency of the thermal interface material is reduced.

Another approach to improving the heat transfer efficiency of thermal interface materials is to provide a kind of compliant and crosslinkable thermal interface material. U.S. Pat. No. 6,605,238 discloses this kind of thermal interface material. The thermal interface material is used for an electronic device, and comprises a silicone resin mixture and a thermally conductive filler. The filler comprises at least one of: (a) silver, copper, aluminum, and alloys thereof; (b) boron nitride, aluminum nitride, aluminum spheres, silver coated copper, silver coated aluminum, and carbon fibers; and (c) mixtures thereof. The amount of the filler is up to 95% of a total amount of the filler and the resin mixture. Because liquid silicone resins cross link to form a soft gel upon heat activation, the thermal performance of the thermal interface material does not degrade even after much thermal cycling of the electronic device.

However, in the above-described thermal interface material, the relative amount of the resin mixture is very small. Thus the resin mixture has a low viscosity, and cannot efficiently retain the filler therein. This reduces the heat conducting efficiency and performance of the thermal interface material.

A new thermal interface material which overcomes the above-mentioned problems and a method for manufacturing such material are desired.

### BRIEF SUMMARY OF THE INVENTION

Accordingly, an object of the present invention is to provide a thermal interface material having excellent heat conduction.

Another object of the present invention is to provide a method for manufacturing the above-described thermal interface material.

To achieve the first of the above-mentioned objects, the present invention provides a thermal interface material comprising comprising a thermal grease and at least one shape memory alloy dispersed in the thermal grease. Said shape memory alloy is selected from the group consisting of a nano-CuNiTi alloy, a nano-CuAlFe alloy, a nano-CuAlNi alloy, a nano-CuZrZn alloy, a nano-CuAlZn alloy, a nano-CuAlFeZn alloy, a nano-NiTiAlCu alloy, a nano-NiTiAlZn alloy and a nano-NiTiAlZnCu alloy. Diameters of particles of said shape memory alloy are in the range from 10 to 100 nanometers. In a preferred embodiment, the diameters of the memory alloy are in the range from 20 to 40 nanometers.

To achieve the second of the above-mentioned objects, a method for manufacturing the thermal interface material comprises the steps of:
(a) providing a thermal grease;
(b) dispersing one or more shape memory alloys in the thermal grease at an operating temperature of a heat source;
(c) applying the thermal grease between the heat source and a heat dissipating device at the operating temperature of the heat source; and
(d) cooling and solidifying the thermal grease to form the thermal interface material.

In the step (c), the thermal grease compactly engages with the heat source and the heat dissipating device. The manufacturing method further comprises the step of peeling the thermal interface material off from the heat source and the heat dissipating device.

Unlike in a conventional thermal interface material, the thermal interface material of the present invention comprises said shape memory alloy, and said shape memory alloy comprises one or more nano-alloys. Thus the thermal interface material has the Shape Memory Effect, and can have a large surface area for large-sized applications. The thermal interface material is formed at the operating temperature of the heat source. In use, the temperature of the heat source rises to the operating temperature, and the thermal interface recovers its former shape and can compactly engage with the heat dissipating device and the heat source. This ensures excellent thermal contact between the heat source and the heat dissipating device. Thus the thermal interface material provides an excellent thermal path between the heat source and the heat dissipating device.

Other objects, advantages and novel features of the invention will become more apparent from the following detailed description when taken in conjunction with the accompanying drawings, in which:

### BRIEF DESCRIPTION OF THE DRAWINGS

FIG. 1 is an enlarged, schematic cross-sectional view of a thermal interface material of the present invention;

FIG. 2 is an isometric view of the thermal interface material of the present invention sandwiched between an electronic device and a heat sink;

FIG. 3 is an enlarged, schematic cross-sectional view showing compact contact states between the thermal interface material and the heat sink, and between the thermal interface material and the electronic device, when the thermal interface material is formed;

FIG. 4 is similar to FIG. 3, but showing incompact contact states between the thermal interface material and the heat sink, and between the thermal interface material and the electronic device, when the thermal interface material is not in use;

FIG. 5 is essentially the same as FIG. 3, showing compact contact states between the thermal interface material and the heat sink, and between the thermal interface material and the electronic device, when the thermal interface material is in use; and

FIG. 6 is a flow chart of a process of manufacturing the thermal interface material of the present invention.

### DESCRIPTION OF THE PREFERRED EMBODIMENTS

Referring to FIG. 1, a thermal interface material 10 comprises a thermal grease 11 and at least one shape memory alloy 12 dispersed in the thermal grease 11. The thermal grease 11 is a silver colloid or a silicon colloid, and comprises a first surface 13 and an opposite second surface 14. Said shape memory alloy 12 is selected from the group consisting of a nano-CuNiTi alloy, a nano-CuAlFe alloy, a nano-CuAlNi alloy, a nano-CuZrZn alloy, a nano-CuAlZn alloy, a nano-CuAlFeZn alloy, a nano-NiTiAlCu alloy, a nano-NiTiAlZn alloy, and a nano-NiTiAlZnCu alloy. Diameters of particles of said shape memory alloy 12 are in the range from 10 to 100 nanometers. In the preferred embodiment, said shape memory alloy 12 is a nano-CuNiTi alloy, and the diameters of the particles of said shape memory alloy 12 are in the range from 20 to 40 nanometers.

Said shape memory alloy 12 has the Shape Memory Effect (SME). U.S. Pat. No. 6,689,486 discloses details of the Shape Memory Effect. The Shape Memory Effect occurs when a shape memory alloy undergoes a phase transformation from a low temperature martensitic phase to a high temperature austenitic phase. In the martensitic phase, the material is deformed by preferential alignment of twins. Unlike permanent deformations associated with dislocations, deformation of the material due to twinning is fully recoverable when the material is heated to the austenitic phase. Similarly, the Shape Memory Effect occurs when the shape memory alloy undergoes a phase transformation from the high temperature austenitic phase to the low temperature martensitic phase.

The thermal interface material 10 of the present invention is formed at an operating temperature of an electronic device 30, and has the above-mentioned Shape Memory Effect. The electronic device 30 is a heat-generating component such as a computer chip. The thermal interface material 10 deforms at a low temperature such as room temperature, and in the deformed state does not compactly engage with the electronic device 30 and a heat sink 20. When the thermal interface material 10 is in use, said shape memory alloy 12 recovers its original shape and compactly engages with the electronic device 30 and the heat sink 20. This ensures that heat produced by the electronic device 30 can be dissipated efficiently. Typically, the heat sink 20 is made of copper, aluminum or an alloy thereof.

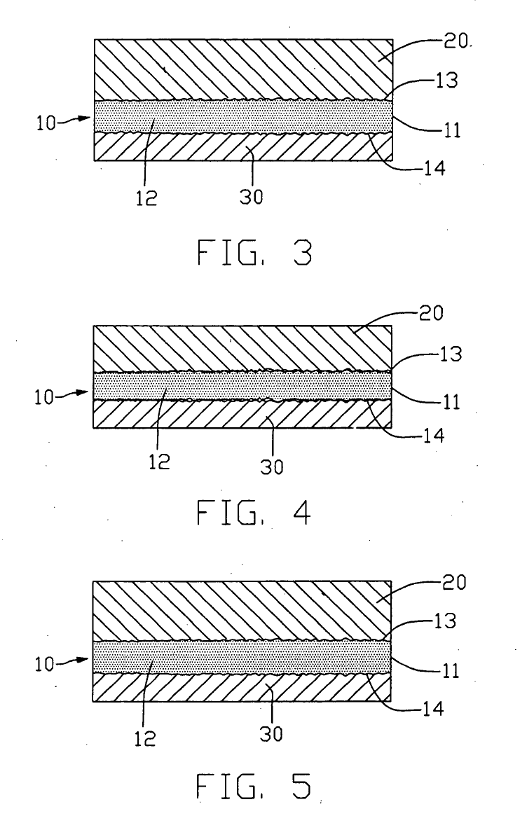

Details of contact states between the thermal interface material 10 and the electronic device 30, and between the thermal interface material 10 and the heat sink 20 are shown in FIGS. 3, 4 and 5. FIG. 3 is an enlarged, cross-sectional view showing a compact contact state between the thermal interface material 10 and the electronic device 30, and between the thermal interface material 10 and the heat sink 20, at the time when the thermal interface material 10 is formed at the operating temperature of the electronic device 30. At this state, said shape memory alloy 12 is in the high temperature austenitic phase. The first surface 13 of the thermal interface material 10 compactly engages with a bottom (not labeled) of the heat sink 20, and the second surface 14 of the thermal interface material 10 compactly engages with a top (not labeled) of the electronic device 30. FIG. 4 is an enlarged, cross-sectional view showing an incompact contact state between the thermal interface material 10 and the electronic device 30, and between the thermal interface material 10 and the heat sink 20, when the thermal interface material 10 is not in use. At this state, the temperature of the thermal interface material 10 is the same as the temperature of the external environment, which is lower than the operating temperature of the electronic device 30. Thus said shape memory alloy 12 is in the low temperature martensitic phase, and the thermal interface material 10 is deformed. Accordingly, the thermal interface material 10 cannot compactly engage with the electronic device 30 and the heat sink 20. FIG. 5 is an enlarged, cross-sectional view showing a compact contact state between the thermal interface material 10 and the electronic device 30, and between the thermal interface material 10 and the heat sink 20, when the thermal interface material 10 is in use. In reaching this state, the temperature of the thermal interface material 10 rises, and said shape memory alloy 12 undergoes a phase transformation from the low temperature martensitic phase to the high temperature austenitic phase. Thus the thermal interface material 10 recovers its shape and can engage with the electronic device 30 and the heat sink 20 compactly.

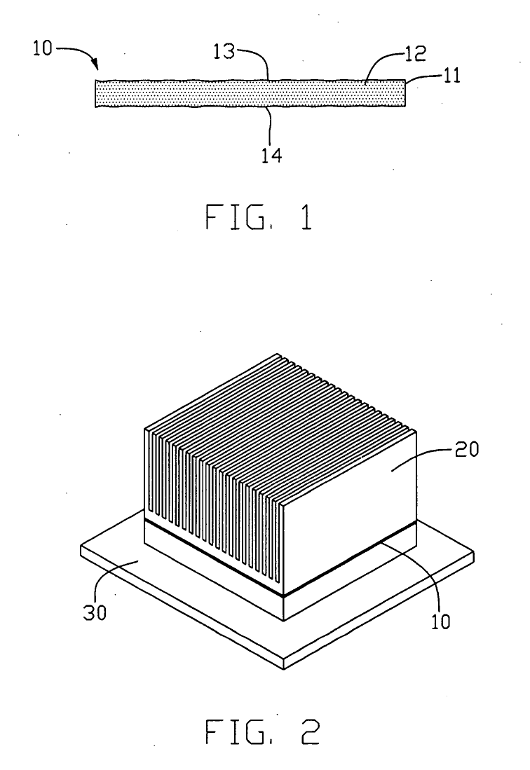

FIG. 2 shows a typical application environment of the thermal interface material 10 of the present invention. The thermal interface material 10 is disposed between the heat sink 20 and the electronic device 30, to provide good heat contact between the heat sink 20 and the electronic device 30. The first surface 13 of the thermal interface material 10 abuts against a bottom (not labeled) of the heat sink 20, and the second surface 14 of the thermal interface material 10 abuts against a top (not labeled) of the electronic device 30. The thermal interface material 10 comprises said shape memory alloy 12, and thus has the Shape Memory Effect. When the electronic device 30 is in use, the temperature thereof rises and the electronic device 30 produces much heat. The heat is transmitted to the thermal interface material 10 and the heat sink 20 in turn. In this process, the temperature of the thermal interface material 10 rises, and said shape memory alloy 12 undergoes a phase transformation from the low temperature martensitic phase to the high temperature austenitic phase. Thus, the thermal interface material 10 recovers its shape and compactly engages with the heat sink 20 and electronic device 30. This ensures excellent thermal contact between the electronic device 30 and the heat sink 20, and the heat produced by the electronic device 30 can be dissipated to the external environment efficiently. In addition, the above-mentioned characteristics of the thermal interface material 10 enable it to have a large surface area for large-sized applications.

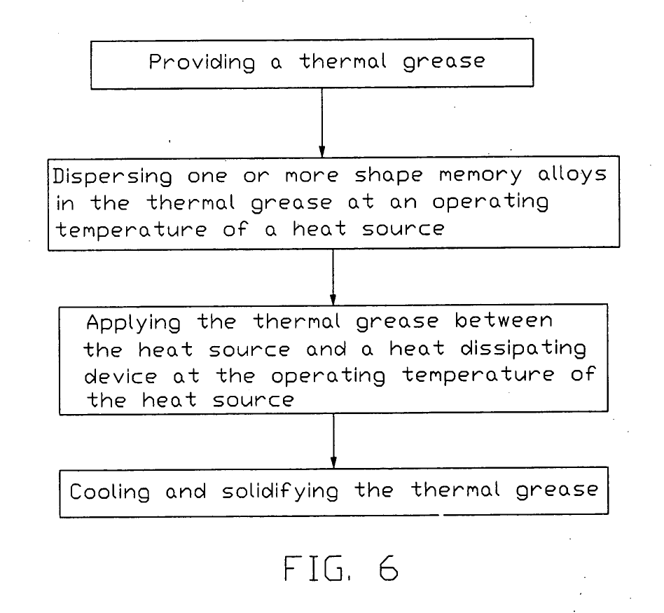

FIG. 6 is a flow chart showing a process of manufacturing the thermal interface material 10. Firstly, the thermal grease 11 is provided. Secondly, said shape memory alloy 12 is dispersed in the thermal grease 11 at the operating temperature of the electronic device 30. Thirdly, the thermal grease 11 is applied on the electronic device 30 and the heat sink 20. Fourthly, the thermal grease 11 is cooled and solidified to form the thermal interface material 10.

In the third step, the thermal grease 11 compactly engages with the electronic device 30 and the heat sink 20. The manufacturing method further comprises the step of peeling the thermal interface material 10 off from the electronic device 30 and the heat sink 20. Said shape memory alloy 12 is selected from the group consisting of a nano-CuNiTi alloy, a nano-CuAlFe alloy, a nano-CuAlNi alloy, a nano-CuZrZn alloy, a nano-CuAlZn alloy, a nano-CuAlFeZn alloy, a nano-NiTiAlCu alloy, a nano-NiTiAlZn alloy and a nano-NiTiAlZnCu alloy. Diameters of particles of said shape memory alloy 12 are in the range from 10 to 100 nanometers. In the preferred embodiment, said shape memory alloy 12 is a nano-CuNiTi alloy, and the diameters of the particles of said shape memory alloy 12 are in the range from 20 to 40 nanometers. If the electronic device 30 is a CPU (central processing unit), the operating temperature of the electronic device 30 is normally in the range from 50 to 100°C. In the preferred embodiment, the operating temperature is 90°C. A force required to compactly engage the thermal interface material 10 with the electronic device 30 and the heat sink 20 is in the range from 49 to 294 newton. In the preferred embodiment, the force is in the range from 98 to 137 newton.

It is understood that the above-described embodiments are intended to illustrate rather than limit the invention. Variations may be made to the embodiments without departing from the spirit of the invention. Accordingly, it is appropriate that the appended claims be construed broadly and in a manner consistent with the scope of the invention.

1. A thermal interface material comprising a thermal grease, wherein at least one shape memory alloy is dispersed in the thermal grease at an operating temperature of a heat source.

2. The thermal interface material as claimed in claim 1, wherein said shape memory alloy is at least one nano-alloy.

3. The thermal interface material as claimed in claim 2, wherein said nano-alloy is selected from the group consisting of a nano-CuNiTi alloy, a nano-CuAlFe alloy, a nano-CuAlNi alloy, a nano-CuZrZn alloy, a nano-CuAlZn alloy, a nano-CuAlFeZn alloy, a nano-NiTiAlCu alloy, a nano-NiTiAlZn alloy, and a nano-NiTiAlZnCu alloy.

4. The thermal interface material as claimed in claim 3, wherein diameters of particles of said shape memory alloy are in the range from 10 to 100 nanometers.

5. The thermal interface material as claimed in claim 1, wherein the thermal grease is a silver colloid or a silicon colloid.

6. The thermal interface material as claimed in claim 1, wherein the thermal grease comprises a first surface adapted to engage with a heat dissipating device, and an opposite second surface adapted to engage with the heat source.

7. A method for manufacturing a thermal interface material, the method comprising the steps of:
(a) providing a thermal grease;
(b) dispersing at least one shape memory alloy in the thermal grease at a predetermined elevated temperature;
(c) applying the thermal grease between a heat source and a heat dissipating device at said temperature; and
(d) cooling and solidifying the thermal grease to form the thermal interface material.

8. The method as claimed in claim 7, wherein said temperature is an operating temperature of the heat source.

9. The method as claimed in claim 8, wherein the operating temperature is in the range from 50 to 100°C.

10. The method as claimed in claim 7, wherein in step (c), the thermal interface material compactly engages with the heat source and the heat dissipating device.

11. The method as claimed in claim 10, wherein a force required to compactly engage the thermal interface material with the heat source and the heat dissipating device is in the range from 49 to 294 newton.

12. The method as claimed in claim 7, further comprising the step of peeling the thermal interface material off from the heat source and the heat dissipating device.

13. The method as claimed in claim 7, wherein the thermal grease is a silver colloid or a silicon colloid.

14. The method as claimed in claim 7, wherein said shape memory alloy is selected from the group consisting of a nano-CuNiTi alloy, a nano-CuAlFe alloy, a nano-CuAlNi alloy, a nano-CuZrZn alloy, a nano-CuAlZn alloy, a nano-CuAlFeZn alloy, a nano-NiTiAlCu alloy, a nano-NiTiAlZn alloy, and a nano-NiTiAlZnCu alloy.

15. The method as claimed in claim 7, wherein diameters of particles of said shape memory alloy are in the range from 10 to 100 nanometers.

16. The method as claimed in claim 7, wherein the heat source is a central processing unit.

17. The method as claimed in claim 7, wherein the heat dissipating device is made of copper, aluminum or an alloy thereof.

18. A thermal interface used between a heat source and a heat dissipating device comprising material containing at least one shape memory alloy therein so as to automatically memorize at least one relative position of said thermal interface between said heat source and said heat dissipating device at a predetermined temperature by means of said at least one shape memory alloy.

19. The thermal interface as claimed in claim 18, wherein said at least one shape memory alloy has at least one nano-alloy.

20. The thermal interface as claimed in claim 18, wherein said at least one shape memory alloy is selected from the group consisting of a nano-CuNiTi alloy, a nano-CuAlFe alloy, a nano-CuAlNi alloy, a nano-CuZrZn alloy, a nano-CuAlZn alloy, a nano-CuAlFeZn alloy, a nano-NiTiAlCu alloy, a nano-NiTiAlZn alloy, and a nano-NiTiAlZnCu alloy.
